(19) United States
(12) Patent Application Publication
(10) Pub. No.: US 2008/0264420 A1
(43) Pub. Date: Oct. 30, 2008

(54) Rotary Valve

(75) Inventor: Roger Leslie Brown, London (GB)

Correspondence Address: ANTHONY R. BARKUME, 20 GATEWAY LANE, MANORVILLE, NY, 11949, US

(73) Assignee: SOUTH BANK UNIVERSITY ENTERPRISES LTD., London (GB)

(21) Appl. No.: 12/089,388

(22) PCT Filed: Oct. 5, 2006
(86) PCT No.: PCT/GB06/50314

§ 371 Date: Apr. 4, 2008

(30) Foreign Application Priority Data
Oct. 5, 2005 (GB) 0520195.9

(51) Int. Cl. A62B 9/02; F16K 5/04

(52) U.S. Cl. 128/205.24; 251/309; 251/129.01

(57) ABSTRACT

A rotary plug valve, especially suitable for providing small pulses of air in which the axis of rotation of the plug is outside the flow path or bore of the valve. The valve opens and closes once in every rotation allowing faster speed motors to be used for the same frequency of air pulses.

The present invention relates generally to rotary fluid flow control valves.

Rotary valves are simple, lightweight, easy to automate, and easy to maintain, come in a variety of materials and end connections, come in a wide range of sizes, are available in multiport configurations, are quick opening and can be adapted to a broad range of services. Plug, ball, and butterfly valves are the major types of rotary valves widely used in industrial plants for flow control in fluid-handling systems. Quarter-turn valves move from fully open to fully closed with a 90° rotation of the closure member and are unique in that the flow condition is indicated by the position of the control handle or actuator.

In a plug valve a rotary cylindrical or tapered plug with an opening through it is inserted into an open body to block or allow the flow of a fluid. When the plug is rotated, it permits flow through the opening and the fluid conduit; a quarter turn in either direction completely blocks the flow path.

A type of plug valve is the eccentric plug valve which is used extensively in the water and waste industry because it offers straight-through flow and high capacity combined with tight shutoff. The design uses a resilient, coated plug segment that rotates 90° from open to closed position into a raised eccentric metal body seat. As the plug closes, it moves toward the seat without scraping the seat or body walls. This eliminates plug binding and wear. The moved member is a plug which is positioned by being rotated about an axis which is normal to, and is offset from, the axis of the cooperating valve seat. They are used particularly when a member is moved to various positions between the open and closed positions in order to adjust the flow rate of a fluid flowing through the valve.

In the eccentric plug valve the rotary valve is of a plate like configuration so that when it is partly open the flow rate of fluid can be accurately controlled and the valve is completely closed twice in every revolution of the valve. An eccentric rotary plug valve is described in U.S. Pat. No. 4,256,285.

The valve is usually sited on the axis of the main bore. This arrangement has several drawbacks when considering motor speed and potential flow restriction in the bore caused by the rotating valve itself, as parts of the valve can never move completely out of the flow path and the valve cutaway will be presented to the flow twice in each valve revolution at 180 degree intervals.

We have now devised a rotary valve which gives a clear flow through with no obstruction and which closes the valve only once in each revolution.

According to the invention there is provided a fluid flow controlling rotary valve comprising (i) a housing containing a fluid flow path with a central axis, (ii) a plug having a sealing face cooperating with said housing in the closed position to block the fluid flow path, (iii) a support shaft arranged to carry said plug means and being rotatable on an axis which is normal to and spaced from the axis of said valve seat and located outside of the flow path so that rotation of the said shaft moves said plug means relative to said housing.

The distance between the axis of the support shalt of the plug means and axis of the fluid flow path is herein called the offset.

When the closed or sealing face of the plug is presented in the bore, flow is totally occluded whilst a 180 degrees rotation of the rotary valve will present a completely open aperture allowing fill flow through the valve assembly without obstruction due to the operating mechanism of the valve. The plug preferably has a plane face and, in the open position, this plane is contiguous with the side of the fluid flow path for smooth flow down the fluid flow path.

The plug means is preferably substantially cylindrical or spherical and has a radius larger than the diameter of the flow path; however the cross-section of the plug may deviate from strict circularity.

If the offset and plug diameter are increased while the width of the sealing face of the plug is maintained as equivalent to the bore diameter, a shorter angular opening period is provided for any given rotational speed, which can prove useful if a specific mechanical timing/angular relationship is desired between the valve assembly and the drive mechanism rotating the plug to operate the valve.

A further increase in the plug diameter and its locating bore can provide a closure seat in the flow-bore for even better sealing characteristics due to the overlap of position with a small overlap at the edges of the plug and the housing to ensure good sealing in this position.

Thus for any given applied pressure or vacuum, the maximum differential pressure will result causing the largest amplitude pulsation.

By introducing variations in the relationship between the width of the sealing face of the plug, port diameter and valve offset, a variety of different conditions may be created to suit the specific application requirement.

The valve offset, diameter and position provide for good sealing when closed, zero flow occlusion when open, and the ability to use a motor-gearbox speed reduction that is half that which is otherwise required with an on-axis rotary valve.

By presenting the sealing face of the plug in the flow path once in each revolution motor speeds are doubled for any given flow pulse rate when compared to conventional on-axis designs which close the valve twice in each revolution; this causes less low-speed motor torque problems.

This is not only a matter for convenience allowing adequate pulse speed from the limited standard ratios that are commercially available, but also generally allows a smaller gearbox to be employed due a lower number of gears or a reduced diameter of gears employed in the gear train, making this configuration more applicable in small to miniature sized mechanical assemblies. For a given plug rotation speed, the motor speed will therefore be effectively doubled. This is of great benefit with small diameter electric motors which often require quite high operating speeds to develop adequate useful driving torque. The valve can be used with any fluid and includes gases and liquids.

The present invention is particularly useful when a small pulse of air is required e.g. 5 to 200 Hz as it provides for rapid opening and closing of the ports giving a short controlled pulse of air.

Patent Application WO 03/077823 describes a breathing apparatus in which the air breathed is interrupted and the present invention is suitable for use in such applications. In this application a valve acts on the flow of air being breathed, and there is a breathing means through which a user can breathe and the valve causes a periodic interruption to air flowing through the valve to the breathing means.

In this application a pulsing effect in the user's breathing processes in the range 10-100 Hz is introduced, which causes an equivalent vibration frequency in the musculature surrounding the lungs and in the human diaphragm. The purpose of this is to cause a vibrated stress condition which recruits more than normal static load related muscle fibres for the purposes of strengthening and exercising this musculature.

The invention is illustrated in the drawings in which:—

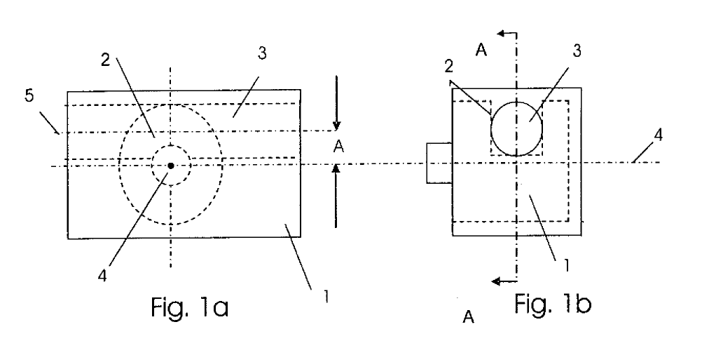

FIGS. 1a and 1b show a plan and elevation view of simple rotary valve;

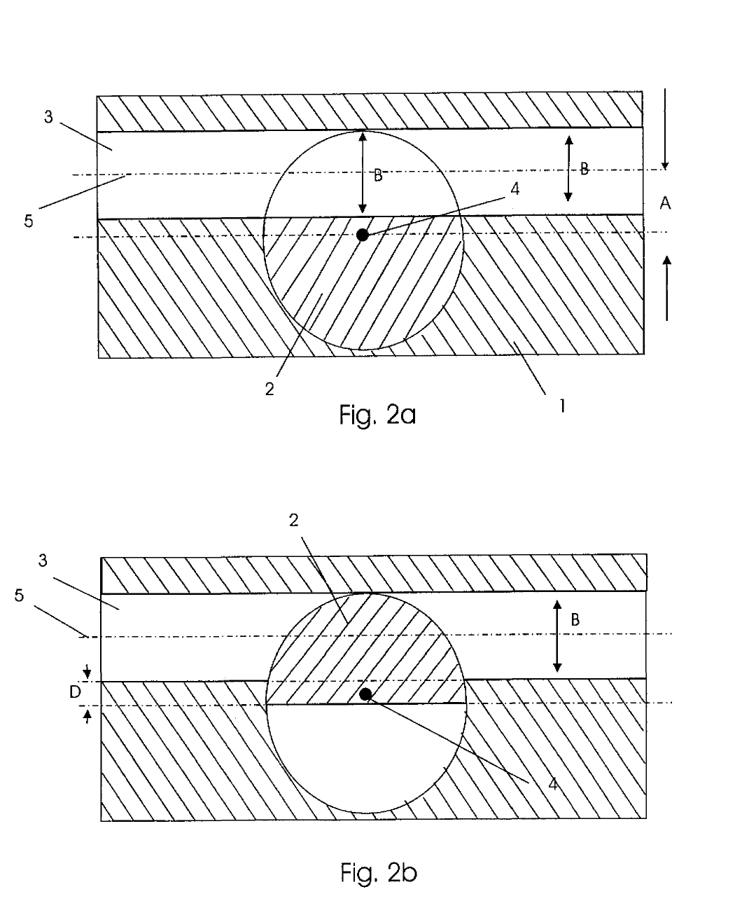

FIG. 2 shows a horizontal section through rotary valve assembly on A-A of FIG. 1b in the open position;

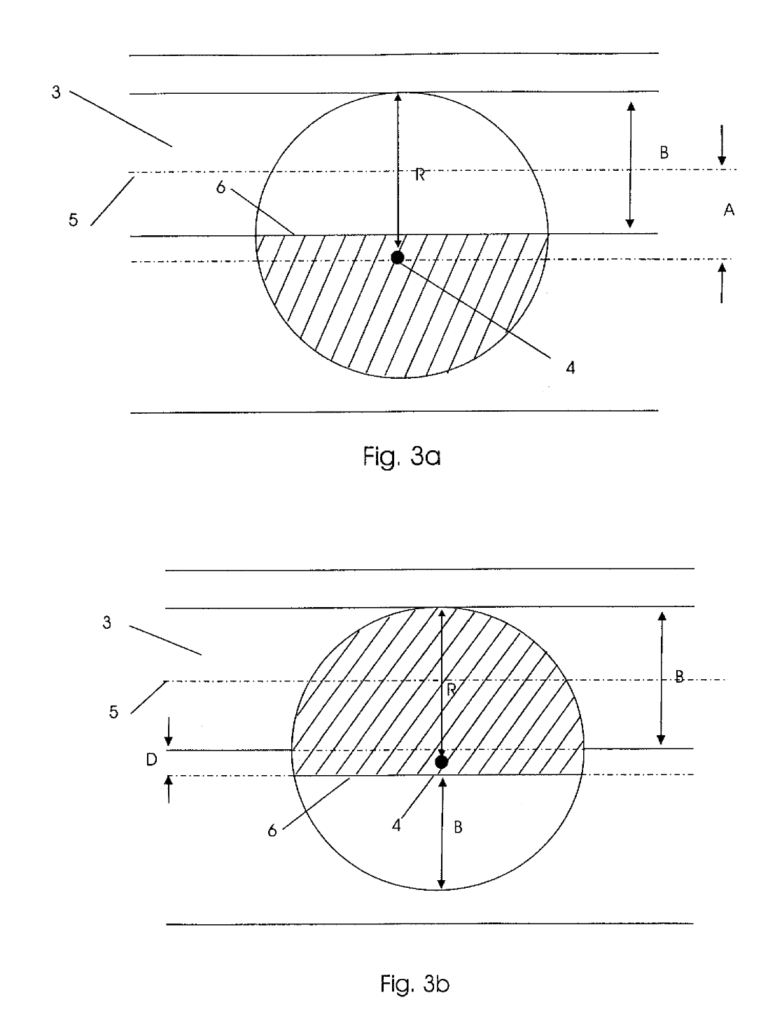

FIG. 3 shows the valve of FIG. 2 in the closed position and

FIG. 4 shows a diagram of the valve of FIG. 2 with dimensions as shown.

Referring to FIGS. 1a and 1b, FIG. 1a is a view along A-A of FIG. 1b. The valve consists of a valve housing (1) which has a fluid flow path (3) through it. There is plug (2) shown in more detail in FIG. 2 which rotates about axis (4) which is at right angles to the axis (5) of the flow path (3) of the valve assembly. The axis (4) is outside the flow path (3).

Referring to FIG. 2a this shows the valve in the opening position. The plug (2) is wholly within the housing (1) and there is no occlusion of the flow path (3). The distance B of plug (2) is equal to the diameter of the flow path (3) and the radius (R) of the plug (2) is larger than the diameter B of the flow path (3). The distance A between the axis (5) of the flow path and the axis of rotation (4) of the plug (2) is the offset.

Referring to FIG. 2b the plug of FIG. 2a is rotated about the axis (4) by 180° to close the valve so no fluid can flow down flow path (3). The distance D is the overlap between the plug (2) and housing (1) shown more clearly in FIG. 4b; the circumference of the plug (2) acts as the sealing face of the plug.

Referring to FIGS. 3a and 3b, in FIG. 3a the valve is in the open position and in FIG. 3b it is in the closed position. The radius (R) of the plug (2) is larger than the distance B from the circumference of the plug (2) and the face of the plug (6). When the plug is in the open position (FIG. 4a) the flow path is not occluded and the plane face (6) of the plug (2) is contiguous with the side of the flow path (3). When the valve is in the closed position (FIG. 4b) the face (6) of the plug is located within the housing (1) and there is an overlap (D) of the plug (2) with the housing (1) which provides a good seal in this position preventing air leakage.

When the plug is used to provide pulses of air, air flows down flow path (3) and the plug (2) rotates. The valve opens and closes once every complete revolution causing the air to pulse down the flow path (3).

1-9. (canceled)

10. Apparatus for delivering a pulsed fluid flow and comprising a rotary valve, and a motor driving said rotary valve;
said rotary valve comprising:
a housing defining a fluid flow path with a central axis and connectable to a supply of fluid;
a plug having a sealing face co-operating with said housing in the closed configuration to block the fluid flow path;
a support shaft arranged to carry said plug and being rotatable on a shaft axis which axis is both normal to and spaced from the central axis and also located outside the flow path whereby rotation of said shaft rotates said plug to alternately occlude fluid flow and free fluid flow once per shaft revolution.

11. Apparatus as claimed in claim 10 and wherein said plug has a face arranged to lie substantially flush with said housing during the free fluid flow portion of said shaft revolution, thereby providing substantially no obstruction to fluid flow in the fluid flow path.

12. Apparatus as claimed in claim 11 and wherein the face of said plug is substantially planar.

13. Apparatus as claimed in claim 10 and wherein said plug is a right cylinder with a radius larger than the diameter of the fluid flow path.

14. Apparatus as claimed in claim 10 and wherein when said valve is in the fully closed configuration the face of said plug is contained within said housing so that there is an overlap between the edges of said plug and said housing.

15. Apparatus as claimed in claim 10 and wherein said motor is arranged for rotating said plug about its axis to open and close said valve at a frequency of 5 to 200 Hz.

16. Apparatus as claimed in claim 10 and wherein the fluid is ambient air and said apparatus is arranged for acting upon a flow of respiratory air to provide air pulsed at a frequency of 10 to 100 Hz.

17. Apparatus as claimed in claim 10 and incorporating a gear train whereby plug rotational speed is reduced by comparison with motor speed.

18. Apparatus for delivering a pulsed flow of respiratory air at a frequency of 10 to 100 Hz and comprising a rotary valve, a motor driving said rotary valve;
said rotary valve comprising:
a housing defining a flow path from a supply of respiratory air, the flow path having a central axis;
a plug having a sealing face co-operating with said housing in the closed configuration to block the flow path, said plug being in the form of a right cylinder with a radius larger than the diameter of the fluid flow path and having a face arranged to lie substantially flush with said housing during the free fluid flow portion of said shaft revolution, thereby providing substantially no obstruction to fluid flow in the fluid flow path;
a support shaft arranged to carry said plug and being rotatable on a shaft axis which axis is both normal to and spaced from the central axis and also located outside the flow path whereby rotation of said shaft rotates said plug to alternately occlude fluid flow and free fluid flow once per shaft revolution.

19. A method of supplying a pulsed flow of fluid comprising passing fluid through a motor driven rotary valve, said rotary valve comprising:
a housing defining a fluid flow path with a central axis;
a plug having a sealing face co-operating with said housing in the closed configuration to block the fluid flow path;
a support shaft arranged to carry said plug and being rotatable on a shaft axis which axis is both normal to and spaced from the central axis and also located outside the flow path whereby rotation of said shaft rotates said plug to alternately occlude fluid flow and free fluid flow once per shaft revolution.

20. A method as claimed in claim 19 and wherein the fluid is respiratory air.

21. A method as claimed in claim 19 and wherein the plug is rotated at 5 to 200 Hz, thereby pulsing the fluid at 10 to 100 Hz.
